(19) United States
(12) Patent Application Publication
(10) Pub. No.: US 2023/0419204 A1
(43) Pub. Date: Dec. 28, 2023

(54) IDENTIFYING SKILL GAPS IN PROJECT TEAMS AND MATCHING WITH AVAILABLE RESOURCES

(71) Applicant: International Business Machines Corporation, Armonk, NY (US)

(72) Inventors: Madhusmita Patil, Hyderabad (IN); Mukundan Sundararajan, Bangalore (IN); Anita Duggal, Delhi (IN)

(21) Appl. No.: 17/809,070

(22) Filed: Jun. 27, 2022

(51) Int. Cl. G06Q 10/06

(52) U.S. Cl. CPC G06Q 10/063112; G06Q 10/06398; G06Q 10/063118

(57) ABSTRACT

In an approach for detecting when a resource gap has opened in a project and deciding how to best utilize the project's resources to fill the resource gap, a processor monitors a degree of progress of one or more projects on a project dashboard. Responsive to detecting a project with a resource gap, a processor obtains a set of data regarding the project. A processor determines a productivity trajectory. Responsive to determining a team member will not meet the productivity trajectory, a processor determines one or more alternative combinations of team members who can meet the productivity trajectory. A processor measures a degree of amplification required to achieve the productivity trajectory by the one or more alternative combinations of team members. A processor identifies one or more resources available to complete a backlog of one or more tasks of the first project. A processor determines an optimum variation.

### BACKGROUND OF THE INVENTION

The present invention relates generally to the field of data processing, and more particularly to a system and method for identifying skill gaps in project teams and matching with available resources.

A project is a unique, transient endeavor, undertaken to achieve a planned objective, which can be defined in terms of an output, an outcome, or a benefit. A project is usually deemed to be a success if it achieves the objectives according to their acceptance criteria, within an agreed upon timeline and budget. To ensure a project is a success, the project must be managed by a professional or a team of professionals who use a variety of skills and knowledge to engage and motivate one or more team members to achieve the planned objective. Project management involves the planning and organization of the project's resources, including deciding how to best utilize the project's resources based on factors including the type of project, the business' needs, and the expertise of team members working on the project, to move the project toward completion. Project management may involve a one-time project or an ongoing activity, and resources managed include personnel, finances, technology, and intellectual property.

### SUMMARY

Aspects of an embodiment of the present invention disclose a method, computer program product, and computer system for detecting when a resource gap has opened in a project and to decide how to best utilize the project's resources to fill the resource gap. A processor monitors a degree of progress of one or more projects of a user on a project dashboard. Responsive to detecting a first project with a resource gap, a processor obtains a set of data regarding the first project. A processor inputs one or more linear measurements and one or more non-linear measurements from the set of data into an Artificial Intelligence model to determine a productivity trajectory. Responsive to determining a team member will not meet the productivity trajectory, a processor determines one or more alternative combinations of team members who can meet the productivity trajectory. A processor measures a degree of amplification required to achieve the productivity trajectory by a combination of team members of the one or more alternative combinations of team members. A processor identifies one or more resources available to complete a backlog of one or more tasks of the first project remaining to be completed and required to achieve the degree of amplification needed for the project. A processor determines an optimum variation, wherein the optimum variation includes the combination of team members and a combination of the one or more resources available to complete the one or more tasks.

In some aspects of an embodiment of the present invention, a processor obtains the backlog of the one or more tasks of the first project remaining to be completed and required to achieve the degree of amplification needed for the project. A processor obtains a list of one or more team members assigned to complete the one or more tasks. A processor obtains one or more linear measures and one or more non-linear measures of the one or more team members assigned to complete the one or more tasks.

In some aspects of an embodiment of the present invention, subsequent to determining the optimum variation, a processor obtains a report on an impact of implementing the optimum variation of the one or more resources available to complete the one or more tasks. A processor updates the Artificial Intelligence model based on the report on the impact.

In some aspects of an embodiment of the present invention, the one or more linear measures include a skills match, a knowledge match, and an experience match.

In some aspects of an embodiment of the present invention, the one or more non-linear measures include motivation, collaboration, challenge to overcome one or more obstacles, and one or more factors from a description of the influence of the project's workforce, and wherein the description of the influence of the project's workforce includes information from a profile of a team member of the project's workforce, a description of the work performed by the team member during a previous project, an assessment of the work performed by the team member during the previous project, feedback given on the work performed by the team member during the previous project, citations from awards or recognitions given to the team member.

In some aspects of an embodiment of the present invention, a processor analyzes the description of the influence of the project's workforce. A processor extracts the one or more factors from the description of the influence of the project's workforce.

In some aspects of an embodiment of the present invention, the one or more factors extracted from the description of the influence of the project's workforce include an intent of the team member extracted from the information from the profile of the team member; a behavior of the team member extracted from the actions in the description of the work performed by the team member during a previous project, wherein the behavior indicates a level of the team member's individual contributions to the previous project; external support received or inferred; and a conflicting view identified in different sentences.

In some aspects of an embodiment of the present invention, a processor evaluates the one or more alternative combinations of team members to determine whether a sustainable rate of productivity is possible with the alternative combination of team members. A processor calculates an overall likely temporal curve to reach the sustainable rate of productivity to determine if the overall likely temporal curve to reach the sustainable rate of productivity is greater than the standard rate of productivity.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a block diagram illustrating a distributed data processing environment, in accordance with an embodiment of the present invention;

FIG. 2 is a flowchart illustrating the operational steps of a workforce amplification program, on a server within the distributed data processing environment of FIG. 1, in accordance with an embodiment of the present invention; and

FIG. 3 is a block diagram illustrating the components of the server within the distributed data processing environment of FIG. 1, in accordance with an embodiment of the present invention.

### DETAILED DESCRIPTION

Embodiments of the present invention recognize that deciding how to best utilize a project's resources is important because it ensures unforeseen delays, overallocation, and burnout are avoided and safety nets are provided. Embodiments of the present invention recognize that current technology fails to address how resources should be utilized if delays, overallocation, or burnout occur when a resource becomes unavailable, thus causing a resource gap. Currently, any additional work is to be divided amongst the team members and requires the team members to expend additional hard work and labor. As a result, additional pressure is placed on the team members and the project to achieve the planned objective. In addition to the added pressure, it may be difficult to find the skills necessary to achieve the planned objective.

Embodiments of the present invention recognize that finding the skills necessary to achieve the planned objective is a “people” resource problem. Consequently, subjective factors and dependencies between factors make for non-linear solutions. For example, current methods of assigning “people” resources are sub-optimal. Further, the performance of the “people” resources varies depending on a standard productivity rate, which can be based on a plurality of factors. Lastly, measuring the likely impact from insights and opinions gathered from the “people” resources for the benefit of the overall project schedule is not done objectively.

Embodiments of the present invention recognize that current methods for moving a project's resources involves several linear models in which “people” resources are modelled as invariant resources. Additionally, these current methods do not solve the problem of unforeseen delays, overallocation, and burnout that may occur. Current methods have tried to make factors, which may have an impact, very small or constant to achieve the time invariant model requirements to enable the requirements to be bounded. The results are not strong and impact the progress that existing “people” resources have to reduce the schedule impacts. Various bridging solutions, such as prior training or prior experience, are used to reduce the onboarding lag and initial low productivity. However, there are no models that function with high accuracy.

Therefore, embodiments of the present invention recognize the need for a system and method to detect when a resource gap has opened in a project and to decide how to best utilize the project's resources to fill the resource gap to ensure unforeseen delays, overallocation, and burnout are avoided and safety nets are provided.

Embodiments of the present invention provide a system and method to detect when a resource gap has opened in a project and to decide how to best utilize the project's resources to fill the resource gap. A resource gap is an issue or a risk that may affect the health of the project. An issue is an event that has happened and may impact the achievement of the project's objectives if not resolved. A risk is a potential event that may impact the achievement of the project's objectives if the event occurs. When a resource gap is not present, the health of the project may be classified as “on track.” “On track” means that the project is on schedule, within scope, and within budget. Project resources are available for project activities when needed. When a resource gap is present, the health of the project may be classified as “at risk” or “off track.” “At risk” means that there are risks and/or issues that may impact the achievement of the project's objectives if not resolved. “Off track” means that there are significant issues that have impacted the achievement of the project's objectives.

Further, embodiments of the present invention obtain the identity of one or more team members assigned to a project's workforce as well as one or more linear measurements of the one or more team members including, but not limited to, a skills match, a knowledge match, and an experience match (e.g., requirements to be achieved, technology, enterprise architecture, business knowledge, and other dimensions). Embodiments of the present invention compare the one or more linear measurements to the needs of the resource gap in real-time. Embodiments of the present invention also obtain non-linear factors of the one or more team members. Non-linear factors include motivation, collaboration, and willingness to challenge oneself to overcome one or more obstacles. The non-linear factors of the one or more team members become critical when a number of resources are only available short term (e.g., a couple of hours a day). The influence of these non-linear factors become critical in enabling these short duration contributors to amplify their work and thus fill the resource gap. Embodiments of the present invention input the linear and nonlinear measurements of the one or more team members into an AI model to determine a productivity trajectory (i.e., an amount of time and a rate to reach a sustainable peak in productivity) and determine if the one or more team members can amplify the work of the project (i.e., accelerate the project's deliverables) to fill the resource gap. Embodiments of the present invention can then find the best match based on a pre-selected optimization rule.

Lastly, embodiments of the present invention consider the characteristics in terms of technical skills and capabilities of short-term team members, partially available team members, and contractors as they become available. The linear and non-linear factors associated with the short-term team members, partially available team members, and contractors become inputs in the AI model. The non-linear factors are extracted from the linguistic description of the team members from interview assessment to prior experiences and the distance between them as well as divergence is measured.

Implementation of embodiments of the present invention may take a variety of forms, and exemplary implementation details are discussed subsequently with reference to the Figures.

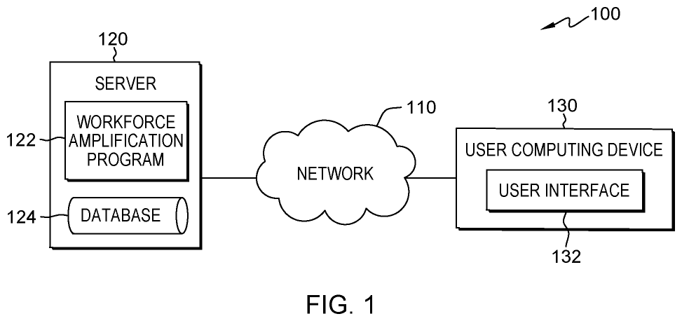

FIG. 1 is a block diagram illustrating a distributed data processing environment, generally designated 100, in accordance with an embodiment of the present invention. In the depicted embodiment, distributed data processing environment 100 includes server 120 and user computing device 130, interconnected over network 110. Distributed data processing environment 100 may include additional servers, computers, computing devices, and other devices not shown. The term “distributed” as used herein describes a computer system that includes multiple, physically distinct devices that operate together as a single computer system. FIG. 1 provides only an illustration of one embodiment of the present invention and does not imply any limitations with regards to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between server 120, user computing device 130, and other computing devices (not shown) within distributed data processing environment 100.

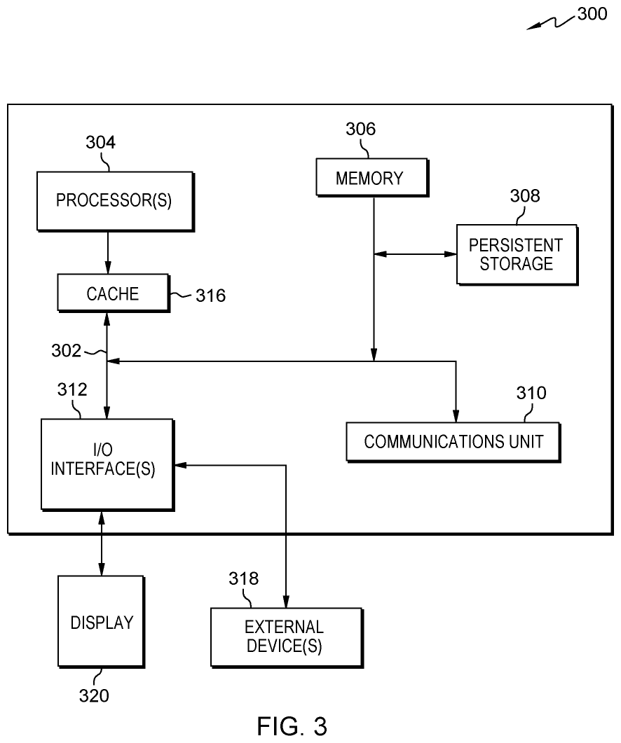

Server 120 operates to run workforce amplification program 122 and to send and/or store data in database 124. In an embodiment, server 120 can send data from database 124 to user computing device 130. In an embodiment, server 120 can receive data in database 124 from user computing device 130. In one or more embodiments, server 120 can be a standalone computing device, a management server, a web server, a mobile computing device, or any other electronic device or computing system capable of receiving, sending, and processing data and capable of communicating with user computing device 130 via network 110. In one or more embodiments, server 120 can be a computing system utilizing clustered computers and components (e.g., database server computers, application server computers, etc.) that act as a single pool of seamless resources when accessed within distributed data processing environment 100, such as in a cloud computing environment. In one or more embodiments, server 120 can be a laptop computer, a tablet computer, a netbook computer, a personal computer, a desktop computer, a personal digital assistant, a smart phone, or any programmable electronic device capable of communicating with user computing device 130 and other computing devices (not shown) within distributed data processing environment 100 via network 110. Server 120 may include internal and external hardware components, as depicted and described in further detail in FIG. 3.

Workforce amplification program 122 operates to detect when a resource gap has opened in a project and to decide how to best utilize the project's resources to fill the resource gap. In the depicted embodiment, workforce amplification program 122 is a standalone program. In another embodiment, workforce amplification program 122 may be integrated into another software product, such as a project management software. In the depicted embodiment, workforce amplification program 122 resides on server 120. In another embodiment, workforce amplification program 122 may reside on user computing device 130 or on another computing device (not shown), provided that workforce amplification program 122 has access to network 110.

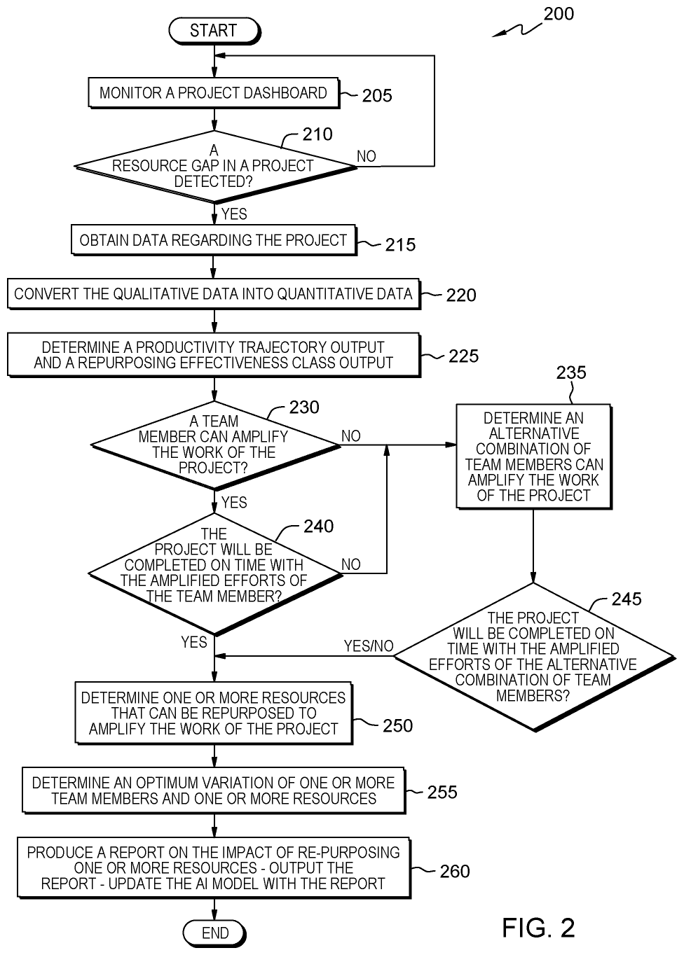

In an embodiment, the user of user computing device 130 registers with workforce amplification program 122 of server 120. For example, the user completes a registration process (e.g., user validation), provides information to create a user profile, and authorizes the collection, analysis, and distribution (i.e., opts-in) of relevant data on identified computing devices (e.g., on user computing device 130) by server 120 (e.g., via workforce amplification program 122). Relevant data includes, but is not limited to, personal information or data provided by the user or inadvertently provided by the user's device without the user's knowledge; tagged and/or recorded location information of the user (e.g., to infer context (i.e., time, place, and usage) of a location or existence); time stamped temporal information (e.g., to infer contextual reference points); and specifications pertaining to the software or hardware of the user's device. In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. Such preferences can be stored in database 124. The operational steps of workforce amplification program 122 are depicted and described in further detail with respect to FIG. 2.

Database 124 operates as a repository for data received, used, and/or generated by workforce amplification program 122. A database is an organized collection of data. Data includes, but is not limited to, information about user preferences (e.g., general user system settings such as alert notifications for user computing device 130); information about alert notification preferences; data relevant to each project of the user (i.e., each previous project, each ongoing project, and each future project); and any other data received, used, and/or generated by workforce amplification program 122.

Database 124 can be implemented with any type of device capable of storing data and configuration files that can be accessed and utilized by server 120, such as a hard disk drive, a database server, or a flash memory. In an embodiment, database 124 is accessed by workforce amplification program 122 to store and/or to access the data. In the depicted embodiment, database 124 resides on server 120. In another embodiment, database 124 may reside on another computing device, server, cloud server, or spread across multiple devices elsewhere (not shown) within distributed data processing environment 100, provided that workforce amplification program 122 has access to database 124.

The present invention may contain various accessible data sources, such as database 124, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Workforce amplification program 122 enables the authorized and secure processing of personal data.

Workforce amplification program 122 provides informed consent, with notice of the collection of personal and/or confidential data, allowing the user to opt-in or opt-out of processing personal and/or confidential data. Consent can take several forms. Opt-in consent can impose on the user to take an affirmative action before personal and/or confidential data is processed. Alternatively, opt-out consent can impose on the user to take an affirmative action to prevent the processing of personal and/or confidential data before personal and/or confidential data is processed. Workforce amplification program 122 provides information regarding personal and/or confidential data and the nature (e.g., type, scope, purpose, duration, etc.) of the processing. Workforce amplification program 122 provides the user with copies of stored personal and/or confidential company data. Workforce amplification program 122 allows the correction or completion of incorrect or incomplete personal and/or confidential data. Workforce amplification program 122 allows for the immediate deletion of personal and/or confidential data.

User computing device 130 operates to run user interface 132 through which a user can interact with workforce amplification program 122 on server 120. In an embodiment, user computing device 130 is a device that performs programmable instructions. For example, user computing device 130 may be an electronic device, such as a laptop computer, a tablet computer, a netbook computer, a personal computer, a desktop computer, a smart phone, or any programmable electronic device capable of running user interface 132 and of communicating (i.e., sending and receiving data) with workforce amplification program 122 via network 110. In general, user computing device 130 represents any programmable electronic device or a combination of programmable electronic devices capable of executing machine readable program instructions and communicating with other computing devices (not shown) within distributed data processing environment 100 via network 110. In the depicted embodiment, user computing device 130 includes an instance of user interface 132.

User interface 132 operates as a local user interface between workforce amplification program 122 on server 120 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from workforce amplification program 122 to a user via network 110. User interface 132 can also display or present alerts including information (such as graphics, text, and/or sound) sent from workforce amplification program 122 to a user via network 110. In an embodiment, user interface 132 is capable of sending and receiving data (i.e., to and from workforce amplification program 122 via network 110, respectively). Through user interface 132, a user can opt-in to workforce amplification program 122; create a user profile; set user preferences and alert notification preferences; input data relevant to each project of the user (i.e., each previous project, each ongoing project, and each future project); input a report of a resource gap in a project; receive an optimum variation; receive a report; receive a request for feedback; and input feedback.

A user preference is a setting that can be customized for a particular user. A set of default user preferences are assigned to each user of workforce amplification program 122. A user preference editor can be used to update values to change the default user preferences. User preferences that can be customized include, but are not limited to, general user system settings, specific user profile settings, alert notification settings, and machine-learned data collection/storage settings. Machine-learned data is a user's personalized corpus of data. Machine-learned data includes, but is not limited to, past results of iterations of workforce amplification program 122.

FIG. 2 is a flowchart, generally designated 200, illustrating the operational steps for workforce amplification program 122, on server 120 within distributed data processing environment 100 of FIG. 1, in accordance with an embodiment of the present invention. In an embodiment, workforce amplification program 122 operates to detect when a resource gap has opened in a project and to decide how to best utilize the project's resources to fill the resource gap. It should be appreciated that the process depicted in FIG. 2 illustrates one possible iteration of the process flow, which may be repeated each time workforce amplification program 122 detects a resource gap in a project.

In step 205, workforce amplification program 122 (hereinafter referred to as “program 122”) monitors a project dashboard. The project dashboard displays data relevant to each project of a user (e.g., each previous project, each ongoing project, and each future project) including, but not limited to, a status of each project (e.g., active (i.e., the project is currently being worked on by one or more team members), completed (i.e., work on the project has finished, and all tasks been completed by one or more team members), cancelled (i.e., the project has not finished and work on the project will not continue), and on hold (i.e., the project has not finished and work on the project has been temporarily suspended)); an updated phase of each project (e.g., planning (i.e., a project workplan is being created), building and implementing (i.e., a project solution is being created or launched), closing (i.e., a project deliverable is being finalized and handed off to the operational team), and completed (i.e., a project is completed and ongoing operations and maintenance have been transitioned to the operational team)); one or more tasks to be completed for each project; the status of the one or more tasks; a list of one or more team members assigned to the project's workforce (e.g., the one or more team members who are assigned to complete the one or more tasks of each project), a respective role of a team member, one or more tasks assigned to a team member, a level of productivity of a team member (i.e., based on a calculation of the efforts expended), one or more resources available and/or assigned to complete the one or more tasks of each project, and the slack (i.e., a number that indicates the amount of time a task can be delayed without impacting subsequent tasks or the project's overall completion) for each of the one or more tasks. In an embodiment, program 122 monitors a project dashboard to track a degree of progress of one or more projects of a user. In an embodiment, program 122 monitors a project dashboard, checking for a resource gap in one or more projects. In an embodiment, program 122 monitors a project dashboard continuously until one or more projects with a resource gap has been detected. In another embodiment, program 122 enables a user to input a report of a resource gap in a project. In an embodiment, program 122 enables a user to input a report of a resource gap in a project through a user computing device (e.g., user computing device 130) via a user interface (e.g., user interface 132).

In decision step 210, program 122 determines whether a resource gap has been detected in a project. If program 122 detects a resource gap in a project (decision step 210, YES branch), then program 122 proceeds to step 215, obtaining data about the project. If program 122 does not detect a resource gap in a project (decision step 210, NO branch), then program 122 continues to monitor the project dashboard. A resource gap is an issue or a risk that may affect the health of the project. An issue is an event that has happened and may impact the achievement of the project's objectives if not resolved. A risk is a potential event that may impact the achievement of the project's objectives if the event occurs. When a resource gap is not present, the health of the project may be classified as “on track.” “On track” means that the project is on schedule, within scope, and within budget. Project resources are available for project activities when needed. When a resource gap is present, the health of the project may be classified as “at risk” or “off track.” “At risk” means that there are risks and/or issues that may impact the achievement of the project's objectives if not resolved. “Off track” means that there are significant issues that have impacted the achievement of the project's objectives.

In step 215, program 122 obtains data about the project. In an embodiment, responsive to project 122 detecting the resource gap in the project, program 122 obtains data about the project. In an embodiment, program 122 obtains data about the project from the project dashboard. In another embodiment, program 122 obtains data about the project from a database (e.g., database 124). In another embodiment, program 122 enables the user to input data about the project through the user computing device (e.g., user computing device 130) via the user interface (e.g., user interface 132). In an embodiment, program 122 obtains data regarding the one or more tasks of the project (e.g., the status of the one or more tasks). In an embodiment, program 122 generates a backlog of the one or more tasks remaining to be completed. In an embodiment, program 122 obtains data regarding the one or more team members assigned to the project's workforce (e.g., the availability of the one or more team members). In an embodiment, program 122 obtains data regarding the one or more resources needed to complete the one or more tasks (e.g., the availability of the one or more resources available and/or assigned to complete the one or more tasks). If the resources available and/or assigned to complete the one or more tasks are only available for a limited amount of time (e.g., one hour a day), then the one or more non-linear measurements are designated as “critical” to ensure the resources are utilized and the output of the resources are amplified.

In an embodiment, if program 122 determines there is a need to hire one or more additional team members, program 122 determines an impact caused by a market on the skills' availability. In an embodiment, program 122 determines a likelihood of hiring success (i.e., a likelihood of internal hiring success and external hiring success). In an embodiment, program 122 determines a level of risk of external fulfilment (i.e., a level of risk associated with hiring external candidates for one or more open team member positions). There may be a plurality of levels of risk. The plurality of levels of risk may include, but are not limited to, mission critical, vital, important, and minor. For example, a risk level of 1 means that repurposing internal team members is mission critical (i.e., external candidates cannot be hired for one or more reasons). In other words, program 122 determines there is a need to hire one or more additional team members. In some cases, it is faster to hire internal candidates for the open team member positions. In other cases, it is faster to hire external candidates for the open team member positions. Hiring external candidates for the open team member positions (i.e., external fulfillment), however, has risks associated with it. If program 122 determines that the level of risk of external fulfillment is too high (e.g., the efforts of the external candidate will not help complete the project on time because the onboarding process for the external candidate will take more time than what is available), then program 122 may suggest repurposing internal candidates. For example, the onboarding process for hiring a mason for masonry work may only be a week-long process because the mason has the skill set and the necessary set of tools already, whereas the onboarding process for hiring a software developer may be a three or four week process because the company may use different tools than the software developer may be used to using and the software developer may need time to learn and become familiar with the new tools.

In an embodiment, program 122 obtains one or more linear measurements of the one or more team members. The one or more linear measurements may include, but are not limited to, a skills match (i.e., a degree of similarity between the skills of the one or more team members and the skills necessary to complete the one or more tasks remaining), a knowledge match (i.e., a degree of similarity between the knowledge possessed by the one or more team members and the knowledge necessary to complete the one or more tasks remaining), and an experience match (i.e., a degree of similarity between the previous experience and achievements of the one or more team members and the previous experience and achievements necessary to complete the one or more tasks remaining) (e.g., requirements to be achieved, technology, enterprise architecture, business knowledge, and other dimensions).

In an embodiment, program 122 obtains one or more non-linear measurements of the one or more team members. In an embodiment, program 122 obtains one or more non-linear measurements from the project dashboard. In another embodiment, program 122 obtains one or more non-linear measurements from the database (e.g., database 124). In another embodiment, program 122 enables the user to input one or more non-linear measurements through the user computing device (e.g., user computing device 130) via the user interface (e.g., user interface 132). The one or more non-linear measurements may include, but are not limited to, a desire and/or willingness of a team member to motivate themselves and other team members, a desire and/or willingness of a team member to collaborate with other team members, and a desire and/or willingness of a team member to challenge themselves and other team members to overcome one or more obstacles. The one or more non-linear measurements may also include, but are not limited to, one or more factors extracted from a description of the influence of the project's workforce in words. The description of the influence of the project's workforce may include, but is not limited to, information (e.g., one or more sentences) from a profile of the one or more team members, a description of the work performed by the one or more team members during a previous project, an assessment of the work performed by the one or more team members during the previous project, feedback given on the work performed by the one or more team members during the previous project, and citations from awards or recognitions (e.g., external mentions and eminence notifications) given to the one or more team members.

In an embodiment, program 122 analyzes the description of the influence of the project's workforce. In an embodiment, program 122 extracts one or more factors from the description of the influence of the project's workforce. The one or more factors extracted from the description of the influence of the project's workforce may include, but are not limited to, an intent of the one or more team members extracted from the profile of the one or more team members; a behavior of the one or more team members extracted from the actions (e.g., through verbs and adverbs) in the description of the work performed by the one or more team members during a previous project, wherein the behavior indicates a level of the one or more team members' individual contributions to the previous project; external support the one or more team members received; and any conflicting views identified.

In step 220, program 122 converts the qualitative terms of the description of the influence of the project's workforce into quantitative terms. In an embodiment, responsive to obtaining data about the project, program 122 converts the qualitative terms of the description of the influence of the project's workforce into quantitative terms (i.e., into numerical values). In an embodiment, program 122 converts the qualitative terms of the description of the influence of the project's workforce into quantitative terms using Natural Language Processing (NLP). In another embodiment, program 122 converts the qualitative terms of the description of the influence of the project's workforce into quantitative terms using Natural Language Understanding (NLU).

The NLP model and the NLU model are initially trained with a description of the influence of the project's workforce (e.g., information from a profile of the one or more team members, a description of the work performed by the one or more team members during a previous project, an assessment of the work performed by the one or more team members during the previous project, feedback given on the work performed by the one or more team members during the previous project, citations from awards or recognitions given to the one or more team members); an assessment of the one or more resources available and/or assigned to complete the one or more tasks of the project; and minutes from meetings regarding the previous projects of the user (i.e., to determine induction, impacts, and issues).

In step 225, program 122 inputs the linear and nonlinear measurements of the one or more team members into an Artificial Intelligence (AI) model. In an embodiment, responsive to converting the qualitative terms of the description of the influence of the project's workforce into quantitative terms, program 122 inputs the linear and nonlinear measurements of the one or more team members into an AI model. In an embodiment, program 122 inputs the linear and nonlinear measurements of the one or more team members into an AI model to produce a multiple class output. The multiple class output includes, but is not limited to, a productivity trajectory output and a repurposing effectiveness class output. The productivity trajectory output is an amount of time and a rate necessary to reach a sustainable peak in productivity. The repurposing effectiveness class output is a degree of effectiveness achieved from repurposing internal team members (i.e., a positive effect achieved from taking one or more internal team members from existing projects with slack and/or non-critical timelines and repurposing the one or more internal team members on a new project with critical timelines).

The AI model is initially trained with data from the previous projects of the user. Data from the previous projects of the user includes, but is not limited to, an impact caused by repurposing the one or more resources available and/or assigned to complete the one or more tasks, an impact caused by hiring additional team members to join the project's workforce, and additional textual inputs obtained from one or more various sources.

Any assessment, feedback, and/or other insight provided is evaluated for bias and conflicts before being considered as appropriate data to train the NLP model, the NLU model, and the AI model. Likewise, the textual inputs obtained from one or more various sources are also evaluated for bias and conflicts before being considered as appropriate data to train the NLP model, the NLU model, and the AI model. A part of the data used to train the NLP model, the NLU model, and the AI model is set aside for a testing corpus.

In decision step 230, program 122 determines if a team member can amplify the work of the project (i.e., accelerate the project's deliverables). In an embodiment, responsive to inputting the linear and nonlinear measurements of the one or more team members into the AI model, program 122 determines if a team member can amplify the work of the project. In an embodiment, program 122 determines if a rate of productivity of the team member is higher than the average standard rate of productivity. In an embodiment, program 122 measures a degree of amplification by the team member on the work of the project using the method of cosine divergence. Program 122 makes this determination for each team member of the project's workforce. This determination assists program 122 in deciding whether an influence of one or more team members will help recover the project through their amplified efforts. If program 122 determines a team member can amplify the work of the project (decision step 230, YES branch), then program 122 proceeds to step 240, determining an amount of impact the team member's amplification will have on the project. If program 122 determines a team member of the project's workforce cannot amplify the work of the project (decision step 230, NO branch), then program 122 proceeds to step 235, determining one or more alternative combinations of team members who can amplify the work of the project.

In step 235, program 122 determines one or more alternative combinations of team members who can amplify the work of the project. In an embodiment, responsive to determining a team member of the project's workforce cannot amplify the work of the project, program 122 determines one or more alternative combinations of team members who can amplify the work of the project.

In decision step 240, program 122 determines an amount of impact the team member's amplification will have on the project. In an embodiment, responsive to determining a team member can amplify the work of the project, program 122 determines an amount of impact the team member's amplification will have on the project. The team member's amplification may be a qualitative term and/or quantitative term. In an embodiment, program 122 determines whether the team member is a team builder. For example, the team members of the project are not working together. This is causing a gap in the project. Program 122 determines whether the team member is a team builder and can motivate the other team members to work together to complete the project. In another embodiment, program 122 determines what additional tasks can be completed by the team member on time, considering the team member's amplified efforts. In an embodiment, program 122 determines what impact the team member's amplified efforts will have on the project's velocity. The project's velocity is the speed at which the project will be completed (e.g., a 1000-hour project can be completed in 10 weeks at a velocity of 100 hours/week or 20 weeks at 50 hours/week). In an embodiment, program 122 determines whether the project can be completed on time with the team member's amplified efforts. Program 122 makes this determination for each team member of the project's workforce who will amplify the work of the project. If program 122 determines the team member's amplified efforts are sufficient to complete the project on time (decision step 240, YES branch), then program 122 proceeds to step 250, determining one or more resources available and/or assigned to complete the one or more tasks that can be repurposed to amplify the work of the project. If program 122 determines the team member's amplified efforts are insufficient to complete the project on time (decision step 240, NO branch), then program 122 returns to step 235, determining whether one or more alternative combinations of team members can amplify the work of the project.

In decision step 245, for the current project, program 122 determines whether the project will be completed on time with the amplified efforts of one or more alternative combinations of team members. In an embodiment, responsive to determining the one or more alternative combinations of team members who can amplify the work of the project (step 235), program 122 determines whether the project will be completed on time with the amplified efforts of one or more alternative combinations of team members. The one or more alternative combinations of team members may include, but is not limited to, one or more team members currently apart of the project and one or more new team members who may join the project. In either case (i.e., determining the project can be completed on time with the amplified efforts of one or more alternative combinations of team members or determining the project cannot be completed on time with the amplified efforts of one or more alternative combinations of team members), program 122 proceeds to step 250, determining one or more resources available and/or assigned to complete the one or more tasks that can be repurposed to amplify the work of the project.

In an embodiment, program 122 determines the total productivity of the one or more alternative combinations of team members. In an embodiment, program 122 determines what impact the amplified efforts of one or more alternative combinations of team members will have on the project's velocity. In an embodiment, program 122 determines whether the project can be completed on time with the amplified efforts of one or more alternative combinations of team members.

In an embodiment, if one or more new team members join the project, program 122 determines an induction trajectory (i.e., how long it will take for the one or more new team members to get up to speed) of the one or more new team members into the project. In an embodiment, if one or more new team members join the project, program 122 determines an onboarding trajectory (i.e., an amount of time and a rate to successfully onboard onto the project).

In another embodiment, for a new project, program 122 evaluates the one or more alternative combinations of workforce members to determine whether a sustainable rate of productivity is possible with the alternative combination of workforce members. In an embodiment, program 122 calculates an overall likely temporal curve to reach a sustainable rate of productivity. In an embodiment, program 122 determines if the overall likely temporal curve to reach the sustainable rate of productivity is greater than the average standard rate of productivity (i.e., that which was assumed during the planning of the project).

In an embodiment, program 122 determines whether a level of productivity of the one or more team members would be impacted if a new project is introduced. In an embodiment, if the level of productivity of the one or more team members would not be impacted if the new project is introduced, program 122 determines an onboarding trajectory for the new project (i.e., a temporal increase in productivity to reach a sustainable peak in productivity).

In step 250, program 122 determines one or more resources available and/or assigned to complete the one or more tasks that can be repurposed to amplify the work of the project. In an embodiment, responsive to determining the team member's amplified efforts are sufficient to complete the project on time (decision step 240, YES branch), responsive to determining the project can be completed on time with the amplified efforts of one or more alternative combinations of team members (decision step 245, YES branch), or responsive to determining the project cannot be completed on time with the amplified efforts of one or more alternative combinations of team members (decision step 245, NO branch), program 122 determines one or more resources available and/or assigned to complete the one or more tasks that can be repurposed to amplify the work of the project. In an embodiment, program 122 determines which resources can be repurposed to amplify the work of the project using functional data about the resources (e.g., name, description/purpose, properties, capabilities, life cycle, operations, etc.) stored in the database (e.g., database 124). In an embodiment, program 122 determines which resources can be repurposed to amplify the work of the project using historical data about the resources (e.g., previous uses, previous results, etc.) stored in the database (e.g., database 124). In an embodiment, program 122 identifies any fitting and/or mis-fitting edges for the one or more resources being introduced into the project.

In step 255, program 122 determines an optimum variation. In an embodiment, responsive to determining one or more resources available and/or assigned to complete the one or more tasks that can be repurposed to amplify the work of the project, program 122 determines an optimum variation. In an embodiment, program 122 determines an optimum variation of one or more team members and/or one or more resources. In an embodiment, program 122 determines an optimum variation that can amplify the work of the project (i.e., amplify the acceleration of the project's deliverables) and can complete the project on time. In an embodiment, program 122 outputs the optimum variation to the user through user interface 132 of user computing device 130.

In step 260, program 122 produces a report. In an embodiment, responsive to determining outputting the optimum variation to the user, program 122 produces a report. In an embodiment, program 122 produces a report on the impact of re-purposing one or more resources available and/or assigned to complete the one or more tasks on the current project. In an embodiment, program 122 outputs the report to the user through user interface 132 of user computing device 130. In an embodiment, program 122 updates the AI model with the set of information contained in the report.

FIG. 3 is a block diagram illustrating the components of computing device 300, suitable for server 120 running workforce amplification program 122 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

As depicted, computing device 300 includes communications fabric 302, processor(s) 304, memory 306, persistent storage 308, communications unit 310, input/output (I/O) interface(s) 312, and cache 316. Communications fabric 302 provides communications between memory 306, cache 316, persistent storage 308, input/output (I/O) interface(s) 312, and communications unit 310. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses or a cross switch.

Memory 306 and persistent storage 308 are computer readable storage media. In this embodiment, memory 306 includes random access memory (RAM). In general, memory 306 can include any suitable volatile or non-volatile computer readable storage media. Cache 316 is a fast memory that enhances the performance of computer processor(s) 304 by holding recently accessed data, and data near accessed data, from memory 306.

Program instructions and data (e.g., software and data) used to practice embodiments of the present invention may be stored in persistent storage 308 and in memory 306 for execution by one or more of the respective processor(s) 304 via cache 316. In an embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308. Software and data can be stored in persistent storage 308 for access and/or execution by one or more of the respective processor(s) 304 via cache 316. With respect to user computing device 130, software and data includes user interface 132. With respect to server 120, software and data includes workforce amplification program 122.

Communications unit 310, in these examples, provides for communications with other data processing systems or devices. In these examples, communications unit 310 includes one or more network interface cards. Communications unit 310 may provide communications through the use of either or both physical and wireless communications links. Program instructions and data (e.g., software and data) used to practice embodiments of the present invention may be downloaded to persistent storage 308 through communications unit 310.

I/O interface(s) 312 allows for input and output of data with other devices that may be connected to each computer system. For example, I/O interface(s) 312 may provide a connection to external device(s) 318, such as a keyboard, a keypad, a touch screen, and/or some other suitable input device. External device(s) 318 can also include portable computer readable storage media, such as, for example, thumb drives, portable optical or magnetic disks, and memory cards. Program instructions and data (e.g., software and data) used to practice embodiments of the present invention can be stored on such portable computer readable storage media and can be loaded onto persistent storage 308 via I/O interface(s) 312. I/O interface(s) 312 also connect to display 320.

Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

While particular embodiments of the present invention have been shown and described here, it will be understood to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understand, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “at least one” or “one or more” and indefinite articles such as “a” or “an”, the same holds true for the use in the claims of definite articles.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart illustrations and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart illustrations and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart illustrations and/or block diagram block or blocks.

The flowchart illustrations and block diagrams in the Figures illustrate the architecture, functionality, and operation of possible implementations of systems, methods, and computer program products according to various embodiments of the present invention. In this regard, each block in the flowchart illustrations or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each flowchart illustration and/or block of the block diagrams, and combinations of flowchart illustration and/or blocks in the block diagrams, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
monitoring, by one or more processors, a degree of progress of one or more projects of a user on a project dashboard;
responsive to detecting a first project with a resource gap, obtaining, by the one or more processors, a set of data regarding the first project;
inputting, by the one or more processors, one or more linear measurements and one or more non-linear measurements from the set of data into an Artificial Intelligence model to determine a productivity trajectory;
responsive to determining a team member will not meet the productivity trajectory, determining, by the one or more processors, one or more alternative combinations of team members who can meet the productivity trajectory;
measuring, by the one or more processors, a degree of amplification required to achieve the productivity trajectory by a combination of team members of the one or more alternative combinations of team members;
identifying, by the one or more processors, one or more resources available to complete a backlog of one or more tasks of the first project remaining to be completed and required to achieve the degree of amplification needed for the project; and
determining, by the one or more processors, an optimum variation, wherein the optimum variation includes the combination of team members and a combination of the one or more resources available to complete the one or more tasks.

2. The computer-implemented method of claim 1, wherein obtaining the set of data regarding the first project further comprises:
obtaining, by the one or more processors, the backlog of the one or more tasks of the first project remaining to be completed and required to achieve the degree of amplification needed for the project;
obtaining, by the one or more processors, a list of one or more team members assigned to complete the one or more tasks; and
obtaining, by the one or more processors, one or more linear measures and one or more non-linear measures of the one or more team members assigned to complete the one or more tasks.

3. The computer-implemented method of claim 1, further comprising:
subsequent to determining the optimum variation, obtaining, by the one or more processors, a report on an impact of implementing the optimum variation of the one or more resources available to complete the one or more tasks; and
updating, by the one or more processors, the Artificial Intelligence model based on the report on the impact.

4. The computer-implemented method of claim 2, wherein the one or more linear measures include a skills match, a knowledge match, and an experience match.

5. The computer-implemented method of claim 2, wherein the one or more non-linear measures include motivation, collaboration, challenge to overcome one or more obstacles, and one or more factors from a description of the influence of the project's workforce, and wherein the description of the influence of the project's workforce includes information from a profile of a team member of the project's workforce, a description of the work performed by the team member during a previous project, an assessment of the work performed by the team member during the previous project, feedback given on the work performed by the team member during the previous project, citations from awards or recognitions given to the team member.

6. The computer-implemented method of claim 5, wherein obtaining the one or more linear measures and the one or more non-linear measures of the one or more team members assigned to complete the one or more tasks further comprises:
analyzing, by the one or more processors, the description of the influence of the project's workforce; and
extracting, by the one or more processors, the one or more factors from the description of the influence of the project's workforce.

7. The computer-implemented method of claim 6, wherein the one or more factors extracted from the description of the influence of the project's workforce include an intent of the team member extracted from the information from the profile of the team member; a behavior of the team member extracted from the actions in the description of the work performed by the team member during a previous project, wherein the behavior indicates a level of the team member's individual contributions to the previous project; external support received or inferred; and a conflicting view identified in different sentences.

8. The computer-implemented method of claim 1, wherein determining the one or more alternative combinations of team members who can meet the productivity trajectory further comprises:
evaluating, by the one or more processors, the one or more alternative combinations of team members to determine whether a sustainable rate of productivity is possible with the alternative combination of team members; and
calculating, by the one or more processors, an overall likely temporal curve to reach the sustainable rate of productivity to determine if the overall likely temporal curve to reach the sustainable rate of productivity is greater than the standard rate of productivity.

9. A computer program product comprising:
one or more computer readable storage media and program instructions stored on the one or more computer readable storage media, the program instructions comprising:
program instructions to monitor a degree of progress of one or more projects of a user on a project dashboard;
responsive to detecting a first project with a resource gap, program instructions to obtain a set of data regarding the first project;
program instructions to input one or more linear measurements and one or more non-linear measurements from the set of data into an Artificial Intelligence model to determine a productivity trajectory;
responsive to determining a team member will not meet the productivity trajectory, program instructions to determine one or more alternative combinations of team members who can meet the productivity trajectory;
program instructions to measure a degree of amplification required to achieve the productivity trajectory by a combination of team members of the one or more alternative combinations of team members;
program instructions to identify one or more resources available to complete a backlog of one or more tasks of the first project remaining to be completed and required to achieve the degree of amplification needed for the project; and
program instructions to determine an optimum variation, wherein the optimum variation includes the combination of team members and a combination of the one or more resources available to complete the one or more tasks.

10. The computer program product of claim 9, wherein obtaining the set of data regarding the first project further comprises:
program instructions to obtain the backlog of the one or more tasks of the first project remaining to be completed and required to achieve the degree of amplification needed for the project;
program instructions to obtain a list of one or more team members assigned to complete the one or more tasks; and
program instructions to obtain one or more linear measures and one or more non-linear measures of the one or more team members assigned to complete the one or more tasks.

11. The computer program product of claim 9, further comprising:
subsequent to determining the optimum variation, program instructions to obtain a report on an impact of implementing the optimum variation of the one or more resources available to complete the one or more tasks; and
program instructions to update the Artificial Intelligence model based on the report on the impact.

12. The computer program product of claim 10, wherein the one or more non-linear measures include motivation, collaboration, challenge to overcome one or more obstacles, and one or more factors from a description of the influence of the project's workforce, and wherein the description of the influence of the project's workforce includes information from a profile of a team member of the project's workforce, a description of the work performed by the team member during a previous project, an assessment of the work performed by the team member during the previous project, feedback given on the work performed by the team member during the previous project, citations from awards or recognitions given to the team member.

13. The computer program product of claim 12, wherein obtaining the one or more linear measures and the one or more non-linear measures of the one or more team members assigned to complete the one or more tasks further comprises:
program instructions to analyze the description of the influence of the project's workforce; and
program instructions to extract the one or more factors from the description of the influence of the project's workforce.

14. The computer program product of claim 9, wherein determining the one or more alternative combinations of team members who can meet the productivity trajectory further comprises:
program instructions to evaluate the one or more alternative combinations of team members to determine whether a sustainable rate of productivity is possible with the alternative combination of team members; and
program instructions to calculate an overall likely temporal curve to reach the sustainable rate of productivity to determine if the overall likely temporal curve to reach the sustainable rate of productivity is greater than the standard rate of productivity.

15. A computer system comprising:
one or more computer processors;
one or more computer readable storage media;
program instructions collectively stored on the one or more computer readable storage media for execution by at least one of the one or more computer processors, the stored program instructions comprising:
program instructions to monitor a degree of progress of one or more projects of a user on a project dashboard;
responsive to detecting a first project with a resource gap, program instructions to obtain a set of data regarding the first project;
program instructions to input one or more linear measurements and one or more non-linear measurements from the set of data into an Artificial Intelligence model to determine a productivity trajectory;
responsive to determining a team member will not meet the productivity trajectory, program instructions to determine one or more alternative combinations of team members who can meet the productivity trajectory;
program instructions to measure a degree of amplification required to achieve the productivity trajectory by a combination of team members of the one or more alternative combinations of team members;
program instructions to identify one or more resources available to complete a backlog of one or more tasks of the first project remaining to be completed and required to achieve the degree of amplification needed for the project; and
program instructions to determine an optimum variation, wherein the optimum variation includes the combination of team members and a combination of the one or more resources available to complete the one or more tasks.

16. The computer system of claim 15, wherein obtaining the set of data regarding the first project further comprises:
program instructions to obtain the backlog of the one or more tasks of the first project remaining to be completed and required to achieve the degree of amplification needed for the project;
program instructions to obtain a list of one or more team members assigned to complete the one or more tasks; and
program instructions to obtain one or more linear measures and one or more non-linear measures of the one or more team members assigned to complete the one or more tasks.

17. The computer system of claim 15, further comprising:
subsequent to determining the optimum variation, program instructions to obtain a report on an impact of implementing the optimum variation of the one or more resources available to complete the one or more tasks; and
program instructions to update the Artificial Intelligence model based on the report on the impact.

18. The computer system of claim 16, wherein the one or more non-linear measures include motivation, collaboration, challenge to overcome one or more obstacles, and one or more factors from a description of the influence of the project's workforce, and wherein the description of the influence of the project's workforce includes information from a profile of a team member of the project's workforce, a description of the work performed by the team member during a previous project, an assessment of the work performed by the team member during the previous project, feedback given on the work performed by the team member during the previous project, citations from awards or recognitions given to the team member.

19. The computer system of claim 18, wherein obtaining the one or more linear measures and the one or more non-linear measures of the one or more team members assigned to complete the one or more tasks further comprises:
program instructions to analyze the description of the influence of the project's workforce; and
program instructions to extract the one or more factors from the description of the influence of the project's workforce.

20. The computer system of claim 15, wherein determining the one or more alternative combinations of team members who can meet the productivity trajectory further comprises:
program instructions to evaluate the one or more alternative combinations of team members to determine whether a sustainable rate of productivity is possible with the alternative combination of team members; and
program instructions to calculate an overall likely temporal curve to reach the sustainable rate of productivity to determine if the overall likely temporal curve to reach the sustainable rate of productivity is greater than the standard rate of productivity.
